(19) United States
(12) Patent Application Publication
(10) Pub. No.: US 2015/0122100 A1
(43) Pub. Date: May 7, 2015

(54) CUTTING BLADE COMPRISING A SECURING CAVITY

(71) Applicant: GEA Food Solutions Germany GmbH, Biedenkopf-Wallau (DE)

(72) Inventor: Jörg Schmeiser, Wiggensbach (DE)

(21) Appl. No.: 14/397,673

(22) PCT Filed: Mar. 28, 2013
(86) PCT No.: PCT/EP2013/056640

§ 371 Date: Oct. 29, 2014

(30) Foreign Application Priority Data
Apr. 30, 2012 (DE) 10 2012 008 427.7

(51) Int. Cl. B26D 7/26

(52) U.S. Cl. CPC B26D 7/2621
USPC 83/674; 29/525.11

(57) ABSTRACT

The invention relates to a cutting blade for a heavy-duty slicing device, comprising a center of rotation and at least one fastening cavity for mounting the cutting blade on the heavy-duty slicing device. The invention further relates to a heavy-duty slicing device and a method for mounting a cutting blade on a heavy-duty slicing device.

The present invention relates to a cutting blade of a heavy-duty slicing device, comprising a center of rotation and at least one fastening cavity for fastening the cutting blade to the heavy-duty slicing device. The present invention also relates to a heavy-duty slicing device and a method for mounting a cutting blade on a heavy-duty slicing device.

Cutting blades of this type are known from the prior art and can be embodied for example as circular blades or sickle blades. These cutting blades rotate at more than 1000 revolutions per minute about the center of rotation thereof and, at the periphery thereof, have a cutting edge, at least in portions, with which the product, in particular a food product, is cut into a number of slices. The cutting blades have at least one fastening cavity, for example a bore, through which a fastening means, for example a screw, is inserted. The fastening means connects the cutting blade to a rotating, driven blade mount of a slicing device. However, the cutting blades according to the prior art have the disadvantage that they are no longer connected to the rotor in the event of a failure of the fastening means, they detach at least in part form the blade mount and may thus cause considerable damage to an object or injury to a person.

The object of the present invention was therefore to provide a cutting blade that does not have the disadvantages of the prior art.

The object is achieved with a cutting blade of a heavy-duty slicing device, comprising a center of rotation and at least one fastening cavity for fastening the cutting blade to the heavy-duty slicing device, wherein the cutting blade additionally has at least one securing cavity.

The statements provided concerning this subject of the present invention apply equally to the other subjects of the present invention and vice versa.

The present invention relates to the cutting blade of a slicing device, with which for example food slabs, in particular slabs of cheese, sausage and/or ham, can be sliced into food slices. To this end, the slicing device has a rotating cutting blade, which rotates about the center of rotation thereof and cuts off the slices from the front end of the product. Here, the cutting blade cooperates with what is known as a cutting edge, which acts as a counterblade and, together with the cutting blade, defines what is known as the cutting plane. An adjustable cutting gap is provided between the cutting blade and the cutting edge and should be as small as possible in order to prevent the slices from being “hacked off”. The cutting gap, however, must be large enough for contact between the cutting blade and cutting edge to be reliably prevented. The cutting blade is arranged on a blade cavity, which is connected to a rotating shaft or is part of a rotating shaft. For the connection of the cutting blade to the blade cavity, the cutting blade has at least one fastening cavity, through which a fastening means, for example a screw, is inserted. As the fastening means is tightened, it fastens the cutting blade to the contact surface of a blade mount. The cutting blade preferably has a number of fastening cavities, which each receive a fastening means. The fastening cavity/cavities preferably is/are arranged at a distance from the center of rotation of the cutting blade. The fastening cavities are particularly preferably arranged opposite one another or in a polygon, for example a triangle. All fastening cavities are particularly preferably located on the same reference circle about the center of rotation.

In order to prevent the cutting blade from detaching in an uncontrolled manner from the contact surface of the blade mount in the event of failure of the fastening means, the cutting blade according to the invention has a securing cavity, through which and/or in which a securing means is inserted. This cavity is not a cavity that receives a fastening means. This securing cavity receives a securing means, which prevents the cutting blade from detaching from the contact surface of the blade mount in the event of failure of the fastening means. Due to the securing cavity in cooperation with the securing means, the cutting blade is prevented from detaching in an uncontrolled manner from the slicing device, for example when the blade mount still rotates. Accidents involving damage to objects and/or injury to people can thus be reliably avoided. A housing possibly provided around the cutting blade can be formed more simply.

The securing cavity is preferably arranged in the center of rotation of the cutting blade. The securing cavity particularly preferably is not rotationally symmetrical in relation to the axis of rotation of the cutting blade. However, the securing cavity is preferably axially symmetrical with respect to at least one central axis, preferably two central axes. The cross section of the securing cavity enlarges with increasing distance from the center of rotation. The securing cavity, in the edge region thereof, particularly preferably has a clamping means, at least in portions, which clamps the cutting blade between the contact surface of the blade mount and the securing means. This clamping means preferably cooperates with a clamping means that, is provided on the blade mount, in particular on the securing means. By way of example, the clamping means is a slanted portion, which cooperates with a slanted portion on the securing means, and the two slanted portions wedge against one another with a relative movement between the cutting blade and the blade mount. Due to the clamping, the cutting blade is additionally secured, in particular against rotation, on the blade mount. This clamping means is preferably formed such that the clamping force increases in the event of failure of the fastening means. Here, or in the event of a failure of a fastening means, an oscillation is produced particularly preferably and is perceived and/or measured by an operator and/or a sensor, which is provided on or in the region of the slicing device. The slicing device can then be switched off, preferably automatically, in a controlled manner on account of this oscillation.

The present invention also relates to a heavy-duty slicing device comprising a rotating cutting blade, which is fastened by means of a fastening means to a contact surface of a blade mount, wherein, in the event of failure of the fastening means, a securing means secures the cutting blade against a detachment from the blade mount.

The statements provided concerning this subject of the present invention apply equally to the other subjects of the present invention and vice versa.

In accordance with the invention, the heavy-duty slicing device has a securing means, which, in the event of failure of at least one, preferably all fastening means with which the cutting blade is fastened to the contact surface of the blade mount of the heavy-duty slicing device, prevents the cutting blade from detaching in an uncontrolled manner from the blade mount, which preferably runs at right angles to the axis of rotation of the cutting blade, and thus prevents the cutting blade from injuring people and/or from damaging objects. The securing means substantially prevents the distance between the contact surface of the blade mount and the cutting blade and/or the angle between the cutting blade and the contact surface of the blade mount from increasing. The securing means is used to be able to switch off the slicing device in a controlled manner for the case that a fastening means fails.

The cross section of the securing means preferably increases continuously, preferably discontinuously, with increasing distance from the contact surface of the cutting blade. The securing means can preferably be changed reversibly in terms of form. One form allows the attachment or removal of the cutting blade to/from the blade mount. Another form prevents this. By way of example, the securing means has a hinge and/or the cross section of the securing means can be enlarged or reduced reversibly. The securing means may consist of a number of individual parts, but is preferably provided in one piece. The securing means and/or the cutting blade is/are preferably provided such that the cutting blade moves slightly in the event of a failure of the fastening means. The cutting blade can thus become wedged and/or can be additionally wedged between the contact surface and the securing means for example, whereby the form fit and/or force fit between the cutting blade and the securing means is increased. The cross-sectional form of the securing means preferably corresponds in portions to the cross section of the securing cavity, wherein the securing means is smaller, preferably slightly smaller, than the securing cavity, such that the securing means can be inserted into or through the securing cavity.

The securing of the cutting blade to the blade mount additionally has the advantage that the attachment of the fastening means is risk-free.

The securing cavity and the securing means preferably overlap with one another following the mounting of the cutting blade on the blade mount, and at any rate overlap with one another in part.

The cutting blade is preferably fastened on the blade mount by means of a bayonet closure. In another preferred embodiment, the securing cavity and the securing means cooperate similarly to a key/keyhole connection.

In a preferred embodiment, the heavy-duty slicing device has an anti-twist mechanism, which prevents the cutting blade from rotating into a position in which it can be removed from the securing means.

The present invention also relates to a method for mounting a cutting blade on a heavy-duty slicing device, in which the cutting blade is fitted onto a blade mount, rotated about the center of rotation thereof and then fastened.

The statements provided concerning this subject of the present invention apply equally to the other subjects of the present invention and vice versa.

The cutting blade is preferably clamped during rotation, in particular between the contact surface of the cutting blade and the securing means. In the event of failure of a fastening means, a relative movement is performed between the securing means and the cutting blade, whereby the clamping force is particularly preferably increased and/or noise is produced.

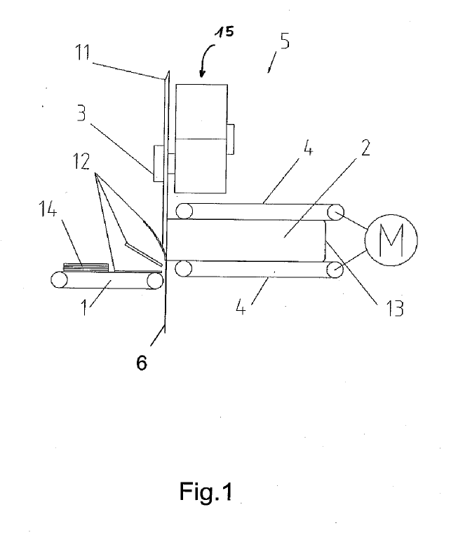

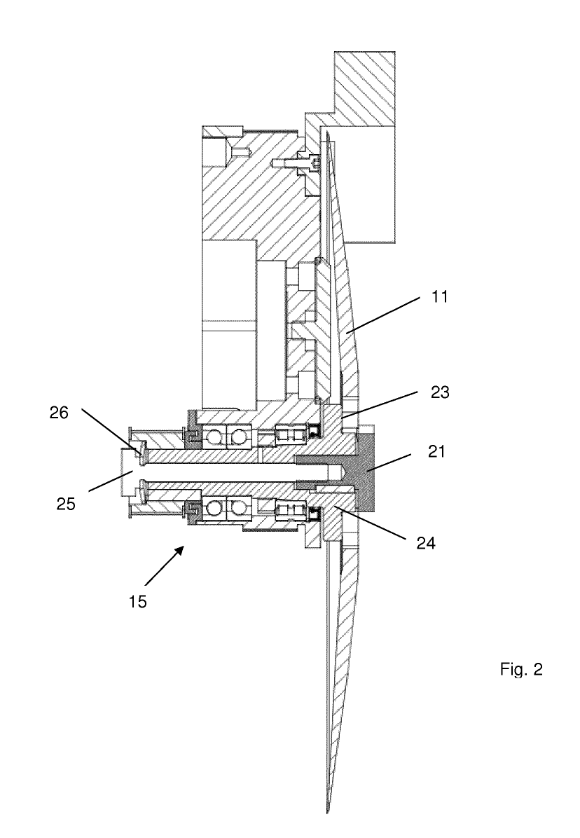

The inventions will be explained hereinafter on the basis of FIGS. 1 and 2. These explanations are merely exemplary and do not restrict the general inventive concept.

FIG. 1 shows the slicing device according to the invention.

FIG. 2 shows the mounting of the cutting blade on the slicing device.

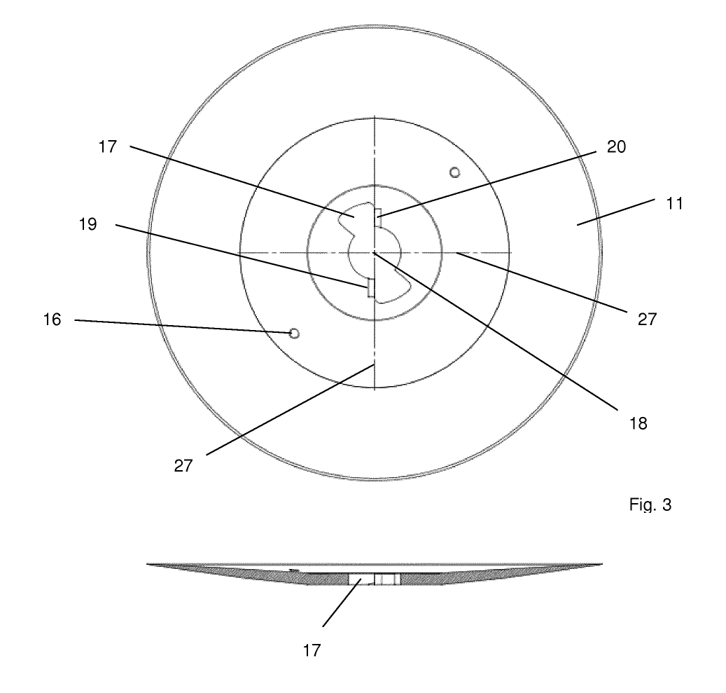

FIG. 3 shows the cutting blade according to the invention.

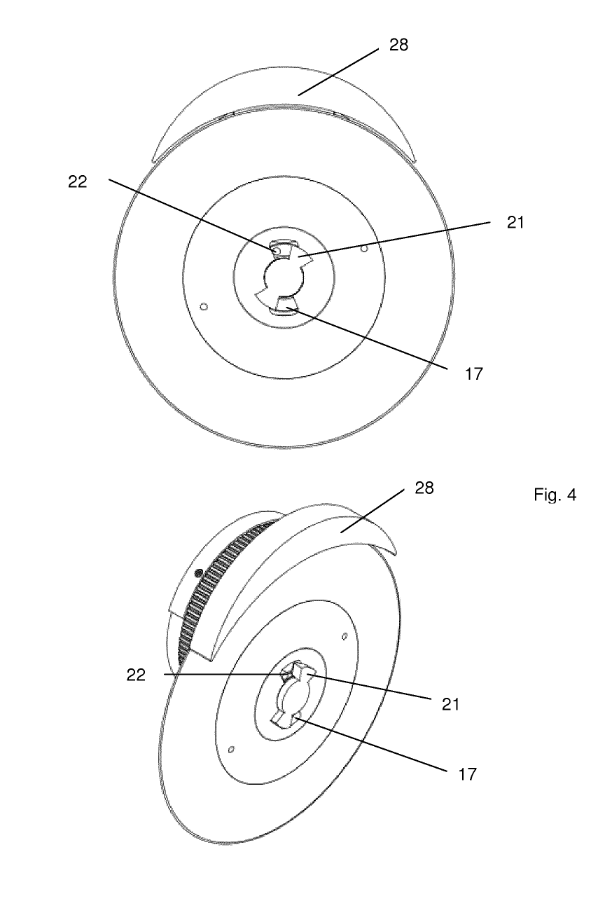

FIG. 4 shows an anti-twist mechanism.

FIG. 1 shows an embodiment according to the invention of a slicing device, in the present case a heavy-duty slicing device, which cuts off up to 1000 slices and more per minute from a product. The slicing device 5 has a blade 11, which cuts a food slab 2 into food slices 12. To this end, each food slab 2 is transported continuously or intermittently by means of a conveyor means 4; here two conveyor belts 4, in the direction of the cutting plane 6 of the blade 11. Following the cutting, the food slices generally fail onto a support table 1, which is provided with transport means, on which the slices are configured so as to form a portion 14 in each case, here a stack. These portions 14 are then transported away from the cutting blade region and are then packaged. A person skilled in the art is aware that a number of food slabs can be cut simultaneously. The slice thickness is given from the feed path of the food slab between two cuts. At constant blade rotational speed, the slice thickness is controlled via the feed rate of the food slab. The slicing device may have a gripper (not illustrated) per feed route, said grippe r grasping the rear end 13 of the food slab 2 prior to or during the slicing, and stabilizing the food slab during the slicing.

So as to have sufficient time for the transporting away of a finished food portion, particularly with very high cutting capacities, the cutting blade preferably performs one or more empty cuts, that is to say it rotates at constant rotational speed, but does not cut any slices from the food slab. To this end, in accordance with the invention, the cutting blade is moved away from, the cutting plane and/or away from the front end of the food slab 2, wherein the feed of the food slab is then at least interrupted. The food slab is even retracted where appropriate. As soon as the respective food portion has been transported away from the failing curve of the food slices, the blade is moved back into the cutting plane and a new portion can be sliced.

FIG. 2 shows the rotor 15 of the slicing device according to the invention. This rotor 15 has a blade mount 24 with a contact surface 23 for the cutting blade 11. The blade mount 24 can be provided in one piece with the drive shaft of the rotor. The cutting blade rests against the contact surface 23 and is fastened to the blade mount by means of at least one fastening means (not illustrated). So as to prevent the cutting blade 11 from detaching in an uncontrolled manner from the contact surface 23 of the blade mount 24 in the event of the failure of the fastening means, the slicing device according to the invention has a securing means 21. The cutting blade is arranged between the contact surface 23 and the securing means 21. The securing means 21 is fastened to the blade mount 24 by means of a fastening means 25, here a screw, A spring means 26 is provided between the head of the screw and the blade mount 24 and biases the fastening means in the direction of the contact surface 23.

FIG. 3 shows the cutting blade 11 according to the invention, in the present case a circular blade, in two views. This circular blade has two fastening cavities 16, which are arranged opposite one another in relation to the center of rotation. The two fastening cavities 16 are located over the same reference circle. A fastening means, here a screw, is introduced into each fastening cavity and is screwed to the blade mount, such that the cutting blade rests fixedly against the contact surface 23 and is connected to the blade mount. In the center, that is to say in the region, of the center of rotation 16, the cutting blade according to the invention has a securing cavity 17. This securing cavity 17 is not rotationally symmetrical and, in the edge region 19 thereof, has a clamping means, here a slanted portion 20, which cooperates with a slanted portion that is provided on the securing means, and thus clamps the cutting blade between the contact surface 23 and the securing means 21.

FIG. 4 shows the secured cutting blade on the rotor 15. Once the securing cavity 17 has been fitted onto the securing means 21 and the cutting blade rests against the contact surface 23, the cutting blade is rotated in an anti-clockwise direction, such that the securing cavity 17 is no longer congruent with the fastening means 21. In the present case, the cutting blade is rotated in an anti-clockwise direction until an anti-twist mechanism 22, which in the present case is mounted in a sprung manner so as to be displaceable, preferably parallel to the axis of rotation of the cutting blade, and which has been pressed by the cutting blade into the contact surface 23, returns back into the securing cavity 17 and thus prevents a rotation of the cutting blade in a clockwise direction. Due to the securing means 17, it is ensured that the cutting blade cannot detach from the contact surface 23. In the case of a failure of the fastening means (not illustrated), the securing means prevents the cutting blade from detaching from the blade mount and thus causing damage to objects and/or injury to people. The slicing device according to the invention can be switched off in a controlled manner in the event of failure. The anti-twist mechanism is then pressed manually in the direction of the contact surface until the cutting blade can be rotated in the clockwise direction so far that the securing cavity 17 and the securing means 21 are congruent. The cutting blade can then be removed from the blade mount along the axis of rotation of the cutting blade.

The cutting blade according to the invention is mounted on the blade mount firstly by fitting the securing cavity of the cutting blade onto the securing means 21 and then by rotating the cutting blade in a clockwise or anti-clockwise direction. The cutting blade is then fastened to the blade mount by means of a fastening means. The cutting blade is preferably fixed during rotation thereof in the fastening position between the contact surface and the securing means.

### LIST OF REFERENCE SIGNS

1 support table
2 food slab
3 means for producing a gas flow, in particular an air flow
4 transport means
5 heavy-duty slicing device
6 cutting plane
7 axial/radial bearing
8 connection means
9 cover
10 blade mount
11 cutting blade, circular blade
12 food slices
13 rear end
14 portion
15 rotor
16 fastening cavity
17 securing cavity
18 center of rotation
19 edge region of the securing cavity
20 clamping means, slanted portion
21 securing means
22 anti-twist mechanism
23 contact surface
24 blade mount
25 fastening means, screw
26 spring means
27 central axis
28 counterweight

What is claimed is:

1. A heavy-duty slicing device comprising:
a rotating blade mount, on which a cutting blade comprising:
a center of rotation and
a number of fastening cavities are provided,
wherein each fastening cavity receives a screw, which when tightened fastens the cutting blade to a contact surface of the cutting blade mount;
wherein the cutting blade additionally has at least one securing cavity, which receives a securing means, which secures the cutting blade against a detachment from the blade mount in the event of failure of the securing means
wherein the securing means is arranged in the center of rotation of the cutting blade and a cross-section of the securing cavity increases with increasing distance from the center of rotation of the cutting blade.

2. The heavy-duty slicing device as claimed in claim 1, wherein in fastening cavity is arranged at a distance from the center of rotation.

3. The heavy-duty slicing device as claimed in claim 1, wherein the securing cavity is arranged in the center of rotation.

4. The heavy-duty slicing device as claimed in claim 1, wherein the securing cavity is not rotationally symmetrical in relation to the axis of rotation of the cutting blade.

5. The heavy-duty slicing device as claimed in claim 1, wherein the securing cavity, in an edge region thereof, has a clamping means, at least in portions.

6. (canceled)

7. The heavy-duty slicing device as claimed in claim 1, wherein the cutting blade is fastened on the blade mount by means of a bayonet closure.

8. The heavy-duty slicing device as claimed in claim 1, wherein the heavy-duty slicing device has an anti-twist mechanism for the cutting blade.

9. A method for mounting a cutting blade on a heavy-duty slicing device, wherein the blade is fitted onto the blade mount, rotated about the center of rotation thereof and then screwed tightly with fastening means, which are each inserted through a fastening cavity, and the cutting blade is claimed during rotation.

10. (canceled)

11. The heavy-duty slicing device as claimed in claim 2, wherein the securing cavity is arranged In the center of rotation.

12. The heavy-duty slicing device as claimed in claim 2, wherein the securing cavity is not rotationally symmetrical in relation to the axis of rotation of the cutting blade.

13. The heavy-duty slicing device as claimed in claim 3, wherein the securing cavity is not rotationally symmetrical in relation to the axis of rotation of the cutting blade.

14. The heavy-duty slicing device as claimed in claim 11, wherein the securing cavity is not rotationally symmetrical in relation to the axis of rotation of the cutting blade.

15. The heavy-duty slicing device as claimed in claim 2, wherein the securing cavity, in an edge region thereof, has a clamping means, at least in portions.

16. The heavy-duty slicing device as claimed in claim 3, wherein the securing cavity, in an edge region thereof, has a clamping means, at least in portions.

17. The heavy-duty slicing device as claimed in claim 14, wherein the securing cavity, in an edge region thereof, has a clamping means, at least in portions.

18. The heavy-duty slicing device as claimed in claim 2, wherein the cutting blade is fastened on the blade mount by means of a bayonet closure.

19. The heavy-duty slicing device as claimed in claim 3, wherein the cutting blade is fastened on the blade mount by means of a bayonet closure.

20. The heavy-duty slicing device as claimed in claim 17, wherein the cutting blade is fastened on the blade mount by means of a bayonet closure.

21. The heavy-duty slicing device as claimed in claim 2, wherein the heavy-duty slicing device has an anti-twist mechanism for the cutting blade.

22. The heavy-duty slicing device as claimed in claim 21, wherein the heavy-duty slicing device has an anti-twist mechanism for the cutting blade.
